(19) United States
(12) Patent Application Publication
(10) Pub. No.: US 2018/0054856 A1
(43) Pub. Date: Feb. 22, 2018

(54) IRRADIATION DEVICE FOR INTRODUCING INFRARED RADIATION INTO A VACUUM PROCESSING CHAMBER USING AN INFRARED EMITTER CAPPED ON ONE END

(71) Applicant: Heraeus Noblelight GmbH, Hanau (DE)

(72) Inventors: Siegfried GROB, Langenselbold (DE); Martin KLINECKY, Gelnhausen (DE); Thomas PIELA, Hanau (DE); Sven LINOW, Darmstadt (DE); Thomas MEYER, Kahl (DE)

(21) Appl. No.: 15/552,986

(22) PCT Filed: Dec. 23, 2015
(86) PCT No.: PCT/EP2015/081155

§ 371 Date: Aug. 23, 2017

(30) Foreign Application Priority Data
Feb. 25, 2015 (DE) 102015102665.1

(51) Int. Cl. H05B 3/00; H01K 7/00; H01K 1/20; H01K 1/40

(52) U.S. Cl. CPC H05B 3/0038; H01K 1/40; H01K 1/20; H01K 7/00

(57) ABSTRACT

An irradiation device for introducing infrared radiation into a vacuum processing chamber has an infrared emitter capped on one end and including an emitter casing tube in the form of a round glass tube, of which a closed end projects into the vacuum processing chamber. A vacuum feedthrough holds the emitter casing tube and leads it in a gas-tight manner through an opening of the vacuum processing chamber. A heating filament and a current return are arranged in the emitter casing tube, wherein the heating conductor has, in the section of the emitter casing tube surrounded by the vacuum feedthrough, a connection element that is led out from the emitter casing tube. The connection element of the heating conductor is guided through a tube section and the return conductor has, in the section of the emitter casing tube surrounded by the vacuum feedthrough, a means for compensating for thermal expansion.

### CROSS-REFERENCE TO RELATED APPLICATIONS

This application is a Section 371 of International Application No. PCT/EP2015/081155, filed Dec. 23, 2015, which was published in the German language on Sep. 1, 2016, under International Publication No. WO 2016/134808 A1 and the disclosure of which is incorporated herein by reference.

### BACKGROUND OF THE INVENTION

The present invention relates to an irradiation device for introducing infrared radiation into a vacuum processing chamber, using an infrared emitter capped on one end, which comprises an emitter casing tube in the form of a round tube made of glass, of which a closed end projects into the vacuum processing chamber, and having a vacuum feedthrough for holding the emitter casing tube and guiding it in a gas-tight way through an opening of the vacuum processing chamber, wherein a heating conductor constructed as a heating filament and a return conductor constructed as a current return are arranged in the emitter casing tube, wherein the heating conductor has, in the section of the emitter casing tube surrounded by the vacuum feedthrough, a connecting element that is led out from the emitter casing tube.

Lamps and infrared emitters (“IR emitters” for short) are known having a heating conductor (also referred to below as heating filament) made of a conductive material having a high melting point. Such heating filaments have the shape of straight wires or sheet metal sections, or the shape of a meander, a belt, a coil, or a loop. A voltage is applied between the ends of the heating filament, so that a current can flow and this generates heat. An infrared emitter therefore has two electrical connection elements, of which one is connected to the heating filament and the other is connected to the current return. The connection elements are led out of the emitter casing tube through seals, also called current feedthroughs.

The operation of infrared emitters in a vacuum or in vacuum processes with reactive atmospheres, in which a significant amount of heat is to be applied to a substrate to be processed in a short amount of time, represents a special challenge to the components and materials in use.

For infrared emitters having a high output, in which the emitter tube is exposed to a high thermal output of the heating filament and which can be used in a high-temperature or chemically aggressive environment, the emitter tube typically consists of a highly siliceous glass, for example quartz glass, which distinguishes itself by a very low coefficient of thermal expansion and a very high temperature resistance. This results in the problem of finding suitable, electrically conductive materials for the heating filaments and their connections, wherein these materials simultaneously have a melting point of greater than 2000° C. and a similar coefficient of thermal expansion throughout the temperature range from room temperature up to the processing temperature of quartz glass. Gas-tight current feedthroughs have a so-called “crimp,” in which a thin molybdenum film is fused as a conductive electrical contact and intermediate element between the inner and outer connection elements, usually in the form of pins, in the crimped-together end of the quartz glass emitter tube. Moreover, in the quartz glass tubes, a considerable radiated power is transported in the axial direction—just like in an optical fiber—so that the thermal expansion of the heating conductor and the current return may not be structurally neglected compared with the thermal expansion of the emitter casing tube. In such emitters, heat builds up even in the area of the tube ends and this affects, in particular, the seals. Here, the decisive factor is the power per emitter length, so that this problem must be taken into account especially for long and high-performance emitters.

If the infrared emitters are mounted in the chamber wall of a vacuum processing chamber, it is also to be taken into account that sparkovers can be generated with the corresponding heating between the electrical supply lines among themselves or to the chamber wall during the transition from a coarse vacuum to a fine vacuum in the residual atmosphere and above a voltage of 80 volts.

The problems mentioned above can indeed be counteracted by an accordingly low operating power of the emitter, which, however, would be counterproductive in the sense of the heating output required for the respective treatment process in the processing chamber.

The mounting of the emitter in the processing chamber wall is possible by the use of flanges on the emitter tube or on the processing chamber wall, wherein these flanges form part of a vacuum feedthrough. Such flanges, however, must be held so that they can move in the direction of the emitter axis against the processing chamber wall, in order not to convert slight thermal expansion into tensile stress that is destructive to the emitter tube: because the thermal expansion of the quartz glass is lower by approximately one order of magnitude than that of the metallic chamber wall, even slight variations of the temperature of the chamber wall or the casing tube made of quartz glass could lead to problems with respect to a compression-resistant and thermally stable seal or current feedthrough. The use of vacuum feedthroughs for emitter tubes is therefore also associated with risks.

From DE 10 2008 063 677 A1, IR emitters are known that are capped on two ends with one round emitter tube or with a dual tube for use in a vacuum processing chamber. The emitters are held on both sides by vacuum feedthroughs in the chamber wall. In the vacuum feedthrough there is, as a seal, an O-ring that fixes the emitter in the sealed position. The emitter has, in the area of the vacuum feedthrough, an opaque tube section that reduces the heating output coming from the IR emitter in the direction of the vacuum feedthrough and the outer crimp sections. The production of such an exactly positioned, opaque tube section is complicated. Therefore, it is preferred to push additional, opaque tube sections made of quartz glass onto the casing tube of the IR emitter. A disadvantage in this arrangement is that an additional component in the form of the pushed-on tube section is required. Moreover, the pushed-on tube section increases the total cross section of the IR emitter in the area of the seal, so that the opening in the vacuum processing chamber wall must also have a corresponding size. In the sense of a space-saving arrangement of the IR emitter and the lowest possible risk for vacuum leakage, however, relatively large openings in the chamber wall are counterproductive.

An IR emitter capped on one end in a vacuum feedthrough of a processing chamber is also disclosed in WO01/35699 A1. The IR emitter is arranged in a quartz glass round tube capped on one end, wherein the infrared radiation source can be connected to an energy source in the vacuum processing chamber, which is not disclosed in more detail. To ensure a high radiation output, a cooling device by air cooling is provided within the emitter tube. The cooling acts on the entire emitter casing tube and here also reduces the heat on the emitter tube end open to the outside in the area of the vacuum feedthrough. The device for corresponding cooling, however, is complicated, susceptible to disruptions, and contradicts the requirement of the most effective possible heating output with respect to the material to be processed in the vacuum processing chamber.

### BRIEF SUMMARY OF THE INVENTION

The object of the invention is therefore to provide an irradiation device for introducing infrared radiation into vacuum processing chambers, in which the disadvantages of the prior art are avoided and safe and reliable operation, especially of long IR emitters, is also ensured in a simple way, without additional components or cooling, even for high heating output.

This object is achieved according to the invention in that, starting from an infrared emitter having the features specified above, the connection element of the heating conductor is guided through a tube section and the return conductor has, in the section of the emitter casing tube surrounded by the vacuum feedthrough, a means for compensating for the heat expansion.

For the irradiation device according to the invention, a safe and reliable operation of the IR emitter that is capped on one end and is guided into the vacuum processing chamber is ensured by multiple complementary features:

In the area of the vacuum feedthrough, the heat transfer to the vacuum seal is reduced by guiding the connection element of the heating conductor in this section of the emitter casing tube in a heat-insulating tube section. Such a relatively short tube section can be pushed onto the connection element without great complication during the production process. The connection element is formed from a straight wire section, wherein a material for the connection element is preferred that has a lower thermal conductivity value than that of the heating conductor. Due to the tube section pushed onto the connection element of the heating conductor, the temperature in the area of the vacuum feedthrough can be reduced during the operation of the IR emitter in comparison to the temperature of the set nominal power of the heating conductor. At the same time, the tube section also prevents the risk that the connection element of the heating conductor comes into contact with the return conductor.

Furthermore, the return conductor has, in the section of the emitter casing tube surrounded by the vacuum feedthrough, a means for compensating for the thermal expansion, which prevents the return conductor from twisting due to its thermal expansion and contacting the heating conductor or forming short circuits in some other way, causing, in addition to the electrical interference function, also locally an especially strong generation of heat. This also enables a central guidance of the return conductor in a narrow space.

The combination of the previously mentioned features produces, overall, a safe and reliable operation and a long service life of the irradiation device with the infrared emitter according to the invention, even at a high output. This is applicable especially for the use of long emitters in which the thermal expansion of the heating conductor and of the return conductor has an especially strong effect. A length expansion of approximately 0.6 mm over 100 mm length for the heating conductor and the return conductor at a temperature of 1000° C. is to be taken into account. In addition to considering the thermal expansion, the measure for reducing the heat transfer to the vacuum feedthrough through the use of the tube section around the connection element of the heating conductor is also to be taken into account. Here, additional measures for cooling the IR emitter at its ends are not required for the irradiation device according to the invention. The infrared emitter according to the invention is also suitable for withstanding vibrations during operation, as long as they do not exceed a deflection of 0.7 mm of the entire emitter in the range from 2 Hz to 10 Hz. In addition, an acceleration of 20 m/s² does not cause any damage to the emitter.

In one preferred embodiment, the tube section through which the heating conductor is guided in the section of the emitter casing tube surrounded by the vacuum feedthrough is constructed as a quartz glass tube, and the connection element of the heating conductor is formed from a wire made of molybdenum or a molybdenum compound.

Due to its heat-insulating effect, quartz glass is an especially suitable material. Furthermore, quartz glass has a very high temperature resistance, so that even if heat builds up in the area of the vacuum feedthrough, this tube section does not deform. In principle, as an alternative to quartz glass, tube sections made of ceramic, high-temperature materials could also be used. With respect to production, however, low material diversity is preferred, so that quartz glass, which is also usually used for the emitter casing tube, also usually represents the preferred material for tube section in question. Furthermore, the connection element of the heating conductor is made of a wire made of molybdenum or a molybdenum compound. In comparison to tungsten, which is typically used as the material for the heating filament, molybdenum has a lower thermal conductivity, so that the use of molybdenum or a molybdenum compound as the material for the connection element of the heating conductor contributes to a reduction of the temperature load in the area of the vacuum feedthrough.

It has proven effective if the means for compensating for the thermal expansion of the return conductor is constructed as a spring element.

The spring element of the return conductor in the section of the emitter casing tube surrounded by the vacuum feedthrough is able to absorb considerable changes in length of a few centimeters, which can occur in long emitters and numerous switching processes during operation. The spring element therefore contributes to the safe and reliable operation of the IR emitter.

Here, the spring element is advantageously constructed in the form of a wire coil, which is wound about the tube section of the connection element of the heating conductor.

In this way, a compact construction within the section of the emitter casing tube is possible in the area around the vacuum feedthrough.

If a wire coil is provided as a means for compensating for the thermal expansion of the return conductor, it is preferred to form this (the means for compensating for the thermal expansion) and the return conductor itself in one piece as a wire made of molybdenum or a molybdenum compound.

In this case, the return conductor has no weld points, but instead is made continuously as a wire made of molybdenum or a molybdenum alloy, which is also used as a connection element for the return conductor and is guided out from the emitter casing tube. With this embodiment, welding processes or other connection types for connecting sections of the return conductor are avoided, which also reduces the risk of flaws in the connections (weld points).

As an alternative to the spring element, the means for compensating the thermal expansion of the return conductor is constructed as a sliding bearing made of carbon, which has at least two electrically conductive sliding bearing elements that are in sliding contact with each other, wherein one of the sliding bearing elements is constructed as a sliding bar and the other sliding bearing element is constructed as a sliding bushing.

The sliding bearing forms an electrically conductive component that enables a force-less compensation of the length expansion of the return conductor. The length compensation is realized here without the effect of a spring just through a material bond fit and conductive, sliding contact of the sliding elements with each other. Carbon, especially graphite, is especially well suited as a bearing material, because its abrasive wearing has a self-lubricating effect. It also provides good electrical conductivity.

For cases in which very large changes in length are to be compensated, even multiple sliding bearings could be provided. It has been shown that such a component fulfills the requirements with respect to electrical conductivity, thermal resistance, and mechanical longevity and contributes to prolonging the service life of infrared emitters, especially even of infrared emitters of large length. Such sliding bearings can also be used as means for compensating for the thermal expansion of the heating conductor.

As further means in the sense of safe and reliable operation of the IR emitter according to the invention, a support element that is connected to the heating conductor is guided in the closed end of the emitter casing tube.

The support element is fixed on one side in the glass wall of the casing tube, for example by fusing, and is connected on the other side to the heating conductor so that this moves essentially only along its longitudinal axis for a change in length due to heating, and relaxing or sagging is counteracted.

In one preferred embodiment of the infrared emitter, the support element is constructed as a bar made of molybdenum or a molybdenum compound, which is guided in the closed end of the emitter casing tube aligned with the heating filament.

Advantageously, the rod made of molybdenum or a molybdenum compound is connected to the heating filament with a positive-locking or material-bond fit, and the guidance in the closed end of the emitter casing tube is realized by a crimped section of the emitter casing tube.

The molybdenum material (or a molybdenum alloy) has proven effective for use in IR emitters due to its temperature resistance. The rod is positioned so that it runs as a support element flush with the heating filament and here is fixed in the glass wall of the casing tube by a crimped section. The connection to the heating filament is a positive-locking fit or a material-bond fit, wherein, for example, a positive-locking fit connection is produced by inserting a round bar into the windings of a coiled heating filament and being encompassed by the windings. A material bond connection is possible by welding the support element to the heating filament. This measure prevents the bending, relaxing, rotation, or sagging of the heating filament if the heating filament undergoes a change in length due to heating.

For producing the crimped sections, crimping machines are used that have, for example, two burners rotating about the emitter casing tube to be crimped and two opposing crimping jaws. As soon as the emitter casing tube is softened, the burner rotation is stopped, so that the crimping jaws are moved past the burners and against the tube and compress the tube, in order to enclose the support element (bar) placed in this tube in the crimped section.

The infrared emitter according to the invention has proven especially advantageous when the return conductor is guided in the section parallel to the heating filament in a quartz glass tube.

Due to the quartz glass tube, the return conductor is isolated relative to the heating conductor, so that electrical sparkovers are not generated. At the same time, the radiation that is output by the heating filament is only slightly shaded by the quartz glass tube surrounding the return conductor, so that this measure causes practically no significant loss of radiation power, but is an improvement with respect to the safe and reliable operation of the IR emitter.

In another preferred embodiment, the heating filament is supported by at least one spacer relative to the inner wall of the emitter casing tube on one side and relative to the return conductor guided in the quartz glass tube on the other side.

The spacer can be provided in the form of a washer made of tantalum, which is shaped by cutouts or slots so that it holds the heating filament and the quartz glass tube guiding the return conductor at a safe distance from each other and from the inner wall of the emitter casing tube. In addition to tantalum, niobium can also be used as the material for the spacer. An advantage in this context is the relatively low thermal conductivity and high specific electrical resistance of tantalum and niobium in comparison to tungsten or molybdenum as materials for the heating conductor and/or the return conductor. The spacer can be held, especially for vertical use of the IR emitter at a certain position along the longitudinal axis of the emitter, by the formation of small glass bumps on the inner wall of the emitter casing tube. Even for long emitters, such spacers are advantageous to ensure orderly guidance, especially of the heating conductor, over the length of the emitter, so that the risk of short circuits by the twisting or sagging of the heating conductor is excluded.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 a first embodiment of the infrared emitter for the irradiation device according to the invention having a return conductor with spring element,

FIG. 2 an alternative embodiment of the infrared emitter having a return conductor with sliding bearing in the area of the vacuum feedthrough,

FIG. 3 a detail view from section A of FIGS. 1 and 2 having a support element on the closed end of the emitter casing tube,

FIG. 4 a spacer for use in the infrared emitter.

### DETAILED DESCRIPTION OF THE INVENTION

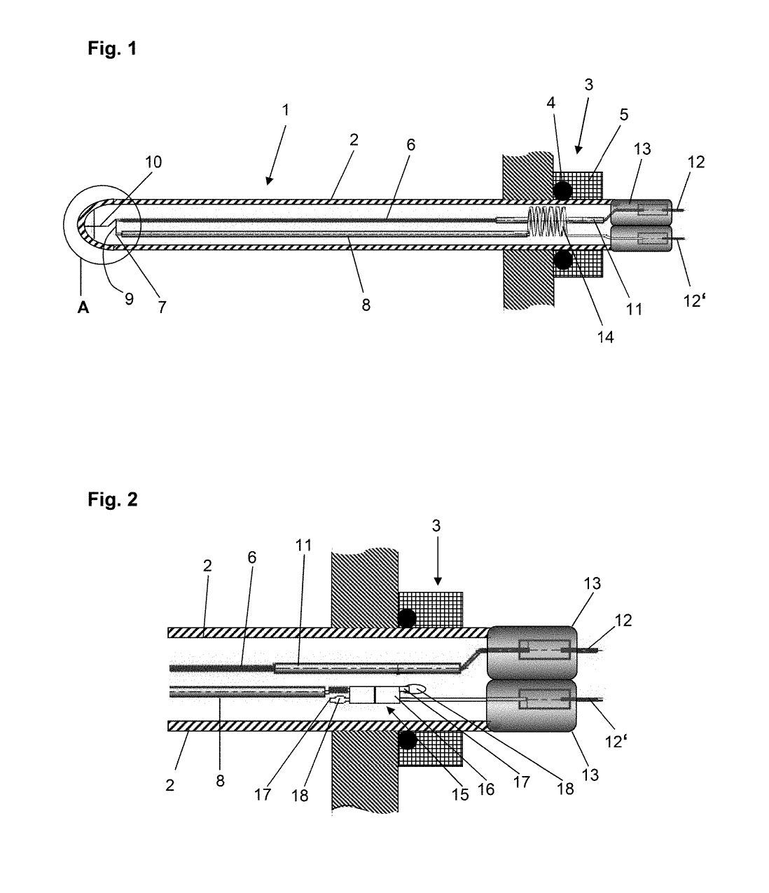

FIG. 1 shows schematically an infrared emitter 1 having an axial-symmetric emitter casing tube 2 made of quartz glass having round cross section (outer diameter 19 mm). The infrared emitter 1 is held by a vacuum feedthrough 3, which comprises a sealing ring 4 and a type of gland 5, in the opening of a vacuum processing chamber and projects with its closed end into the vacuum processing chamber. The IR emitter 1 is designed for an operating temperature above 800° C.

In the emitter casing tube 2 there is a coil-shaped heating conductor 6 (heating filament) made of tungsten having a (heated) length of 140 cm and a return conductor 7 (current return). The return conductor 7 is guided parallel to the heated area of the heating conductor 6 in a quartz glass tube 8. In the area of the closed end of the emitter casing tube 2, the heating conductor 6 and return conductor 7 are connected to each other by a short connecting piece 9. Furthermore, a support element 10 is located there, which represents a holder for the heating conductor 6 and which is fixed in the emitter casing tube 2.

In the section of the emitter casing tube that is in the area of the vacuum feedthrough 3, a short tube 11 of 60 to 80 mm length made of quartz glass is pushed onto the connection element 12 of the heating conductor 6, which greatly reduces the heat transfer to the seal 4 of the vacuum feedthrough 3. In the area of the vacuum feedthrough 3, due to the tube 11 made of quartz glass pushed onto the connection element 12, the temperature is below approximately 250° C., while the heating conductor 6 reaches temperatures of up to 2500° C. in the area of the usable length of the IR emitter. On the heating conductor 6 and on the return conductor 7, electrical connection elements 12, 12′ are welded, which are guided out of the emitter casing tube 2 via crimped sections 13 lying outside of the vacuum feedthrough 3 to a not-shown connector base.

The return conductor 7 has, in the area of the vacuum feedthrough 3, a spring element 14 in the form of a wire coil. The wire coil comprises up to eight windings on an axial length section of 15 mm and is wound about the short quartz glass tube 11 that is pushed onto the connection element 12 in this section of the heating conductor 6. Due to the wire coil the thermal length expansion of the return conductor 7 is compensated for, whereby an expansion of 8 mm results from operation of the IR emitter at 2500° C.

FIG. 2 shows only the area of the IR emitter 1 lying in the area of the vacuum feedthrough 3. In contrast to FIG. 1, the means for compensating for the thermal expansion is not a spring element, but instead a sliding bearing 15 made of a high-purity technical carbon, which is connected to the return conductor 7. The sliding bearing 15 is a friction-supported distance compensating element having a sliding bushing 16 with two passage holes that each hold, in pairs, a sliding bar 17 made of molybdenum in sliding fit H7/h7. The sliding bars have a diameter of 1.4 mm. One sliding bar is connected by welding to the molybdenum wire of the return conductor 7 and the other sliding bar is also connected by welding to the electrical connection element 12′ of the return conductor 7, which is led out from the end of the casing tube 2. To compensate for the difference in the diameter of the molybdenum wire of the return conductor 7 (wire diameter approximately 0.9 mm) relative to the molybdenum bar of the sliding bearing (diameter 1.4 mm), the molybdenum wire is wound at the welding point with a few turns on the sliding bar and then welded. The ends of the sliding bars opposite the molybdenum wire connection of the return conductor 7 and the connection to the connection element 12′ project out of the sliding bushing part and are provided with a thicker section 18, which prevents the sliding bars 17 from sliding out of the sliding bushing 16. The sliding bearing 15 forms an electrically conductive component between the return conductor 7 and the connection element 12′, which permits a force-less compensation of the length expansion of the return conductor 7 during operation. The length compensation here takes place without a spring effect just by a material-bond fit, and conductive, sliding contact of the sliding elements with each other.

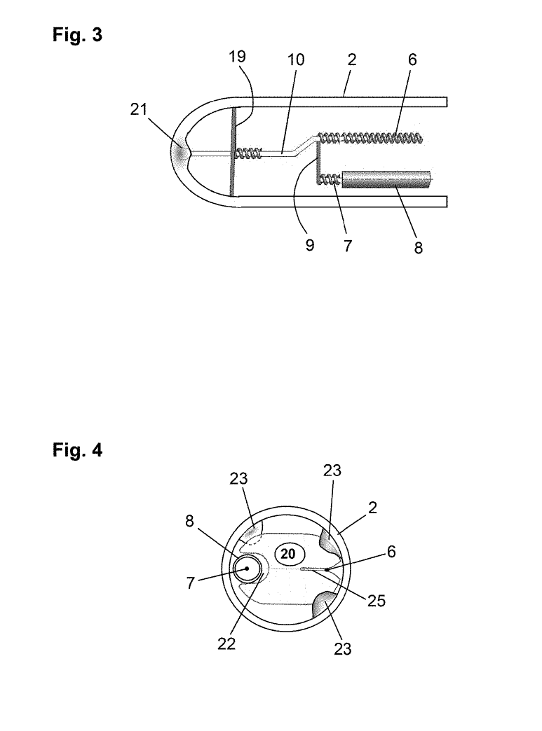

In FIG. 3 the section A of FIG. 1 with the closed end of the emitter casing tube 2 is shown in a detailed view. A support element 10 constructed as a round bar made of molybdenum is fixed in the glass wall of the casing tube 2 by a crimped section 13.1 [sic 21]. In addition, the bar is held by a support coil 19 adapted to the inner diameter of the emitter casing tube 2 and contacts the inner wall of the casing tube 2. The diameter of the bar is 0.875 mm and is adjusted so that it can be inserted into the windings of the heating filament 6 with a positive (form) fit. The bar is designed so that the heating filament 6 does not sag, even in the event of thermal expansion and the associated loss of stiffness, but instead is guided in an essentially aligned manner, that is, remains in its radial position. In this way, the risk is minimized that thermal expansion will cause the heating filament 6 to contact the return conductor 7 in this section and thus cause a short circuit. Further in FIG. 3, a connection piece 9 can be seen between the heating conductor 6 and return conductor 7, which, in this case, is a wire piece made of molybdenum having a few windings at both ends, which are welded to the heating conductor 6 and to the return conductor 7. As the connection piece 9, however, there is also a straight wire without windings or another sheet metal part that can be used, which is welded to the heating conductor or return conductor and which fulfills the corresponding electrical requirements.

FIG. 4 shows a cross section through the emitter casing tube 2 in the area of the heated length, where multiple spacers 20 made of tantalum are provided for the purpose of the exact positioning of the heating conductor 6 and return conductor 7 in the emitter casing tube 2. The spacer 20 is supported relative to the inner wall of the emitter casing tube 2 on one side and relative to the return conductor 7 guided in the quartz glass tube 8 on the other side, wherein the spacer 20 has a guide slot 25 and an open, circular cutout 22. The heating conductor 6 is guided in the guide slot 25 and the open, circular cutout 22 holds the quartz glass tube 8 surrounding the return conductor 7. In this way, the heating conductor 6 and the quartz glass tube 8 guiding the return conductor 7 are held at a safe and reliable distance from each other and from the inner wall of the emitter casing tube 2. The spacer 20 is held on the inner wall of the emitter casing tube by small glass bumps or knobs 23 that fix the spacer 20 especially for the vertical use of the IR emitter at a certain position along the longitudinal axis of the emitter. One or more spacers of this type ensure, even for long emitters, proper guidance, especially of the heating conductor, over the length of the emitter.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-11. (canceled)

12. Irradiation device for introducing infrared radiation into a vacuum processing chamber, having an infrared emitter capped on one end and comprising an emitter casing tube in the form of a round tube made of glass, of which a closed end projects into the vacuum processing chamber, and having a vacuum feedthrough for holding the emitter casing tube and leading it in a gas-tight manner through an opening of the vacuum processing chamber, wherein a heating conductor constructed as a heating filament and a return conductor constructed as a current return are arranged in the emitter casing tube, wherein the heating conductor has, in the section of the emitter casing tube surrounded by the vacuum feedthrough, a connection element that is led out from the emitter casing tube, wherein the connection element of the heating conductor is guided through a tube section and the return conductor has, in the section of the emitter casing tube surrounded by the vacuum feedthrough, a means for compensating for thermal expansion.

13. Infrared emitter according to claim 12, wherein tube section through which the connection element of the heating conductor is guided is constructed as a quartz glass tube and the connection element of the heating conductor is constructed from a wire made of molybdenum or from a molybdenum connection.

14. Infrared emitter according to claim 12, wherein the means for compensating for thermal expansion of the return conductor is constructed as a spring element.

15. Infrared emitter according to claim 14, wherein the spring element is constructed in the form of a wire winding, which is wound about the tube section of the connecting element of the heating conductor.

16. Infrared emitter according to claim 14, wherein the means for compensating for thermal expansion of the return conductor and the return conductor are constructed in one piece as a wire made of molybdenum or a molybdenum compound.

17. Infrared emitter according to claims 12, wherein the means for compensating for thermal expansion of the return conductor is constructed as a sliding bearing made of carbon and has at least two electrically conductive sliding bearing elements in sliding contact with each other, wherein one of the sliding bearing elements is constructed as a sliding bar and the other sliding bearing element is constructed as a sliding bushing.

18. Infrared emitter according to claim 12, wherein, in the closed end of the emitter casing tube, a support element is guided, which is connected to the heating conductor.

19. Infrared emitter according to claim 18, wherein the support element is constructed as a bar made of molybdenum or a molybdenum compound, which is guided in the closed end of the emitter casing tube aligned with the heating conductor.

20. Infrared emitter according to claim 19, wherein the bar made of molybdenum or a molybdenum compound is connected to the heating conductor in a positive-locking or material-bonding fit and the guidance in the closed end of the emitter casing tube is realized by a crimping of the emitter casing tube.

21. Infrared emitter according to claim 12, wherein the return conductor is guided in the section parallel to the heating conductor in a quartz glass tube.

22. Infrared emitter according to claim 21, wherein the heating conductor is supported by at least one spacer relative to the inner wall of the emitter casing tube on one side and relative to the return conductor guided in the quartz glass tube on the other side.
